(19) United States
(12) Patent Application Publication
(10) Pub. No.: US 2014/0308538 A1
(43) Pub. Date: Oct. 16, 2014

(54) SURFACE TREATED ALUMINUM FOIL FOR ELECTRONIC CIRCUITS

(71) Applicant: GBC Metals, LLC, East Alton, IL (US)

(72) Inventor: Szuchain F. Chen, Hamden, CT (US)

(73) Assignee: GBC Metals, LLC, East Alton, IL (US)

(21) Appl. No.: 14/216,502

(22) Filed: Mar. 17, 2014

Related U.S. Application Data
(60) Provisional application No. 61/792,549, filed on Mar. 15, 2013.

(51) Int. Cl. B32B 15/01

(52) U.S. Cl. CPC B32B 15/017; B32B 2457/08
USPC 428/607

(57) ABSTRACT

The surface of an aluminum substrate is modified to enhance the adhesion of the metal to polymeric materials. Intermediate layers, such as Zn/Sn, Co/Ni, and a Cu strike are applied before depositing a nodular Cu layer for bond enhancement. The surface treated aluminum substrate can be used in printed circuit boards, leadframes, or any electrical/electronic devices where Cu is typically used to reduce the cost and weight of the devices.

### CROSS-REFERENCE TO RELATED APPLICATIONS

This application claims priority to U.S. Provisional Patent Application Ser. No. 61/792,549, filed Mar. 15, 2013. The entire disclosure of the above-referenced application is incorporated herein.

### FIELD

The present disclosure relates to aluminum foils for use in electronic circuits and other applications, and in particular to surface treated aluminum foils.

### BACKGROUND

This section provides background information related to the present disclosure which is not necessarily prior art.

Copper foil is widely used in electronic circuits and other similar applications. However, copper is relatively expensive and heavy. Aluminum foil, although not as conductive as copper foil, is less expensive and lighter. However, a problem with using aluminum foil is improving the adhesion of the foil to substrates, such as circuit board material. Conventional adhesion treatments are not effective because aluminum has a very negative electrochemical potential. This negative electrochemical potential of aluminum causes spontaneous deposition of other metals that have a more positive potential, when the aluminum is in contact with ions of more noble metals such as Cu, Ni, and Zn, resulting in spongy and non-adherent deposits. This is called a displacement reaction or immersion coating. In general, the resulting deposits are spongy and non-adherent to their fast deposition rate, rendering the deposits useless.

### SUMMARY

This section provides a general summary of the disclosure, and is not a comprehensive disclosure of its full scope or all of its features.

Generally, this invention relates to improving the adhesion of aluminum foil. Embodiments of this invention provide a surface treatment for aluminum foil, and an aluminum foil with such a surface treatment.

A preferred embodiment of an aluminum foil in accordance with the principles of this invention has a zinc layer, a nickel layer over the zinc layer, a copper strike, and a copper nodule treatment.

According to another embodiment of this invention, a zinc layer is applied to the aluminum foil from an alkaline zincate solution, or a tin layer applied from an alkaline stannate solution, or the combination of zinc and tin alloys. A nickel or cobalt or their alloy layer is deposited over the zinc/tin layer. A copper strike is deposited over the nickel/cobalt layer, and copper nodule treatment is applied over the copper strike.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an enlarged cross-sectional view of an aluminum foil with a surface treatment in accordance with the principles of this invention; and

FIG. 2 is a flow chart of a method of treating the surface of aluminum foil in accordance with the principles of this invention.

Corresponding reference numerals indicate corresponding parts throughout the several views of the drawings.

### DETAILED DESCRIPTION

Example embodiments will now be described more fully with reference to the accompanying drawings.

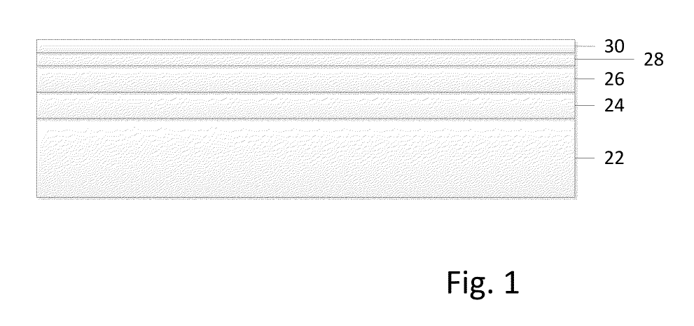

An aluminum foil composite with a surface treatment in accordance with the principles of this invention is indicated generally as 20 in FIG. 1. The aluminum foil composite comprises an aluminum foil layer 22, which can be of aluminum or an aluminum alloy with a thickness of between about 6 μm and about 800 μm, and more preferably between about 10 μm and about 400 μm. A zinc layer 24 is provided over at least one face of the aluminum foil layer 22. A nickel layer 26 is provided over the zinc layer 24. A copper strike or copper flash layer 28 is provided over the nickel layer 26. Finally, a copper nodule layer 30 is provided over the cooper strike or copper flash layer 28.

The zinc layer 24 is preferably substantially pure zinc metal, and preferably is between 0.05 μm and about 0.8 μm, and more preferably between about 0.15 μm and about 0.5 μm, thick. The zinc layer 24 can be conveniently deposited on the aluminum foil from an alkaline zincate solution by immersion.

The nickel layer 26 is preferably substantially pure nickel, and preferably is between 0.2 μm and about 1.5 μm, and more preferably between about 0.25 μm and about 0.5 μm, thick.

The copper strike or copper flash layer 28 is preferably substantially pure copper, and preferably is between about 0.2 μm and about 1.5 μm, and more preferably between about 0.25 μm and about 0.5 μm, thick.

The copper nodule layer 30 is preferably between about 0.2 μm and about 10 μm thick, and more preferably between about 1 μm and about 5 μm thick. This nodule layer can be applied in any manner, including according to the methods disclosed in U.S. Pat. Nos. 4,549,941 and 4,568,431, the entire disclosures of which are incorporated herein by reference.

Alternatively, a Cu strike layer can be deposited onto the Zn layer from an alkaline Cu solution in place of the Ni strike. The alkaline Cu strike solution is typically cyanide-based, but non-cyanide plating solutions have also been developed in recent years by companies such as MacDermid and Enthone. The advantage of using a Cu strike layer instead of Ni layer is more consistent with the existing circuit manufacturing process without introducing new elements. Ni layer may be more difficult to etch during the PCB processing, and special procedures may need to be introduced.

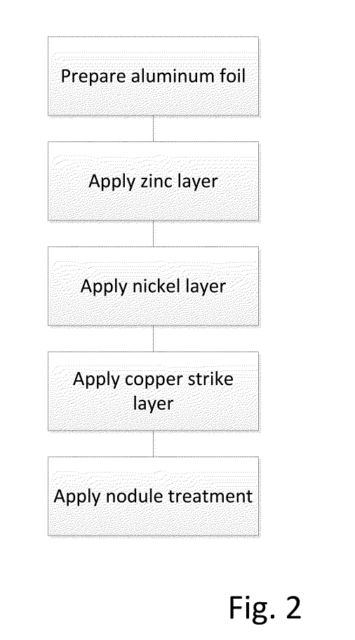

A preferred embodiment of a method of making a surface treated aluminum foil is indicated generally as 100 in FIG. 2. The method 100 comprises at 102, depositing a zinc layer 24 on the aluminum layer 22. An example is a solution containing 15-23 g/l ZnO, 83-98 g/l NaOH, 4.5-6.0 g/l NaNO₃ at 75-85° F. for 0.5-2 min.

At 104, a nickel layer 26 is deposited over the zinc layer 24.

At 106, a copper flash or copper strike layer 28 is deposited over the nickel layer 26.

At 108, copper nodules 30 are formed on the copper flash or copper strike layer 28.

### EXAMPLE 1

An Al foil 150 μm thick was electrocleaned in a solution containing 10 g/l NaOH and 10 g/l sodium metasilicate pentahydrates at a temperature of 140° F., using a current density of 40 asf (ampere per square foot) for 7 seconds. The foil was then immersed in a zincate solution containing 18 g/l Zn as ZnO, 90 g/l NaOH at ambient temperature (about 73° F.) for 15 seconds. An Ni layer was plated on top of the Zn layer in a solution containing 30 g/l Ni as nickel sulfate and 30 g/l sodium sulfate at pH about 2.0 and temperature of 140° F., using a current density of 160 asf for 11 seconds. A Cu strike layer was plated in a solution containing 18 g/l Cu and 90 g/l sulfuric acid at 95° F., using a current density of 183 asf for 3 seconds, followed by 34 asf for 20 seconds. A Cu nodule treatment was then given in the same solution at a current density of 122 asf for 13 seconds. A P2 (Cr—Zn oxides) antitarnish coating was applied onto the Cu nodules as in a standard CopperBond® process. A tape test was applied to the sample, and the coatings were adherent, showing no peeling effect. Comparatively, when the zincate deposition step was omitted, the coating could be peeled in the tape test.

Aluminum foil in accordance with at least some of the embodiments of this invention, has a lower cost than the Cu foil; the price of aluminum being less than that of copper. Aluminum has more surface areas than Cu foil, about 3.3 times surface areas than for Cu foil of the same weight and thickness. Thus, 3.3 times areas of PCB can be made for the same weight of foil. Even when slightly thicker, aluminum foil is used to compensate for the lower electrical and thermal conductivities compared with Cu, the cost saving of aluminum is still substantial. The lower weight of aluminum foil can be advantageous in the end use of the foil, such as in portable consumer electronics and automotive applications.

The surface treated aluminum foil can be adhered to polymeric circuit board materials, or other applications where copper foil or plate is typically used.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A surface treated aluminum foil composite, comprising:
an aluminum foil layer;
a zinc layer on at least one face of the aluminum foil;
a nickel layer over the zinc layer;
a copper strike over the nickel layer; and
adhesion enhancing copper nodules on the copper strike.
